(19) United States
(12) Patent Application Publication
(10) Pub. No.: US 2025/0065762 A1
(43) Pub. Date: Feb. 27, 2025

(54) INFORMATION PROCESSING APPARATUS, SYSTEM AND METHOD

(71) Applicant: Ubiden, Inc., Tokyo (JP)

(72) Inventors: Norio Yamaguchi, Tokyo (JP); Tatsuro Shiraishi, Tokyo (JP); Shuhei Onishi, Tokyo (JP); Hitoshi Ikeda, Tokyo (JP)

(73) Assignee: Ubiden, Inc., Tokyo (JP)

(21) Appl. No.: 18/455,719

(22) Filed: Aug. 25, 2023

(51) Int. Cl. B60L 53/66; B60L 53/65

(52) U.S. Cl. CPC B60L 53/665; B60L 53/65

(57) ABSTRACT

In supplying an energy from an energy output section to an energy supply target, an inequality in usage fees among users, an inequality in provision fees among providers, or both is corrected. An information processing apparatus for managing a use of energy comprises a fee calculation section for calculating the usage fee to be fee-charged to the user, based on information regarding an energy supply amount received by the energy supply target of the user from the energy output section of the provider, and at least one of information on an energy supply speed at the time of an energy supply from the energy output section to the energy supply target, information on a type of generation method of the energy received by the energy supply and information on a type of the energy supply target receiving the energy supply.

### TECHNICAL FIELD

The present invention relates to information processing apparatuses, systems and methods for managing a provision, a use, or both of an energy such as an electric power.

### BACKGROUND ART

A system for managing a use of an electric power via an electrical outlet is conventionally known. For example, Patent Literature 1 discloses a system provided with a power-supply gate apparatus that controls a power supply, a server apparatus (information processing apparatus) that manages usage fees according to a supply amount of the electric power supplied from the power-supply gate apparatus, a mobile outlet (energy output section) that connects the power-supply gate apparatus and an electric vehicle (energy supply target). After the electric power from the power-supply gate apparatus is output from the mobile outlet and supplied to the electric vehicle, a current power supply amount (energy supply amount) detected by the power usage integrator of the mobile outlet is transmitted from the mobile outlet to the server apparatus, and then the server apparatus calculates a usage fee of the electric power from the received power supply amount.

### CITATION LIST

### Patent Literature

Patent Literature 1: Japanese Unexamined Patent Application Publication No. 2002-325357.

### SUMMARY OF INVENTION

### Technical Problem

Conventionally, when an energy is supplied from the energy output section to the energy supply target of a user, the usage fee charged to the user is calculated based only on the energy supply amount. However, with such a calculation method of the usage fee, an inequality in the usage fees may occur among users.

In addition, when the energy is supplied from the energy output section of a provider to the energy supply target, if the provision fee paid to the provider is also calculated based only on the energy supply amount, an inequality in the provision fees may occur among providers.

### Solution to Problem

An information processing apparatus according to an aspect of the present invention is an information processing apparatus for managing a use of an energy, and comprises a fee calculation section for calculating a usage fee to be fee-charged to a user, based on information regarding an energy supply amount received by an energy supply target of the user from an energy output section of a provider, and at least one of information on an energy supply speed at the time of an energy supply from the energy output section to the energy supply target, information on a type of generation method of the energy received by the energy supply and information on a type of the energy supply target receiving the energy supply.

In the foregoing information processing apparatus, the fee calculation section may calculate a provision fee to be paid to the provider based on information regarding the energy supply amount and the at least one of information.

An information processing apparatus according to another aspect of the present invention is an information processing apparatus for managing a provision of an energy, and comprises a fee calculation section for calculating a provision fee to be paid to a provider, based on information regarding an energy supply amount supplied by an energy output section of the provider to an energy supply target of a user, and at least one of information on an energy supply speed at the time of an energy supply from the energy output section to the energy supply target, information on a type of generation method of the energy received by the energy supply and information on a type of the energy supply target receiving the energy supply.

In the foregoing information processing apparatus, the fee calculation section may add a fee for using or providing a parking space in which the energy supply target is parked within a disposing area where the energy output section is disposed, to the usage fee, the provision fee, or both.

A system according to still another aspect of the present invention is a system for managing a use and/or a provision of energy, and comprises the foregoing information processing apparatus according to any one of claims 1 to 4 and a transmission apparatus for transmitting the at least one of information to the information processing apparatus.

A method according to still another aspect of the present invention is a method for managing a provision of an energy, and comprises calculating a provision fee to be paid to a provider, based on information regarding an energy supply amount supplied by an energy output section of the provider to an energy supply target of a user, and at least one of information on an energy supply speed at the time of an energy supply from the energy output section to the energy supply target, information on a type of generation method of the energy received by the energy supply and information on a type of the energy supply target receiving the energy supply.

### Advantageous Effects of Invention

According to the present invention, it is possible to correct the inequality in the usage fees among users, the inequality in the provision fees among providers, or both, when the energy is supplied from the energy output section to the energy supply target.

### BRIEF DESCRIPTION OF DRAWINGS

FIG. 1 is an explanatory diagram showing a disposing area in which an electrical outlet configuring a power-usage management system according to an embodiment 1 is disposed.

FIG. 2 is an explanatory diagram showing an example of a schematic configuration of the power-usage management system according to the embodiment 1.

FIG. 3 is a block diagram showing an example of a configuration of main functions of a server which configures the power-usage management system according to the embodiment 1.

FIG. 4 is a sequence diagram showing an example of a process in the power-usage management system according to the embodiment 1.

FIG. 5 is an explanatory diagram showing a disposing area in which an electrical outlet configuring a power-usage management system according to an embodiment 2 is disposed.

FIG. 6 is an explanatory diagram showing an example of a schematic configuration of the power-usage management system according to the embodiment 2.

FIG. 7 is a block diagram showing an example of a configuration of main functions of a server which configures the power-usage management system according to the embodiment 2.

FIG. 8 is a sequence diagram showing an example of a process in the power-usage management system according to the embodiment 2.

### DESCRIPTION OF EMBODIMENTS

### Embodiment 1

Hereinafter, an embodiment of the present invention (hereinafter, this embodiment will be referred to as “embodiment 1”) is described with reference to the drawings.

A system according to the present embodiment of the present invention is a system that manages a use of an energy supplied from an energy output section to an energy supply target. The energy to be supplied may be, for example, a primary energy in the form of oil, natural gas, coal, or the like, or a secondary energy in the form of electricity, hydrogen, gasoline, light oil, heavy oil, city gas, alcohol, or the like.

An energy supply target to which an energy is supplied is, for example, an electric moving body driven by a battery-mounted motor. The moving body may be a moving body moving on the ground such as an electric vehicle or a fuel cell vehicle, a moving body moving through the air such as a drone, or a moving body such as a ship moving on water such as the sea. The moving body may be a vehicle having four or more wheels, a three-wheeled vehicle (tricycle), a two-wheeled vehicle (motorcycle, bicycle), a truck, a bus, a private vehicle, a commercial vehicle, or the like. The energy supply target may be owned by the user oneself, may be leased from a leasing company, or may be owned by a business-operator different from the user. Further, the energy supply target may be an electric device or an electronic device such as a portable or stationary home appliance, an office device and a communication terminal apparatus.

In the following embodiment, as an example, a case is described in which an energy to be supplied is an electric energy, an energy output section that outputs the energy is an electrical outlet that outputs an electrical energy, an energy supply target to which an energy is supplied is a vehicle or a battery which is installed in the vehicle, and a system is a power-usage management system that manages a power usage when electrically charging the battery of the vehicle with the electric power output from the electrical outlet.

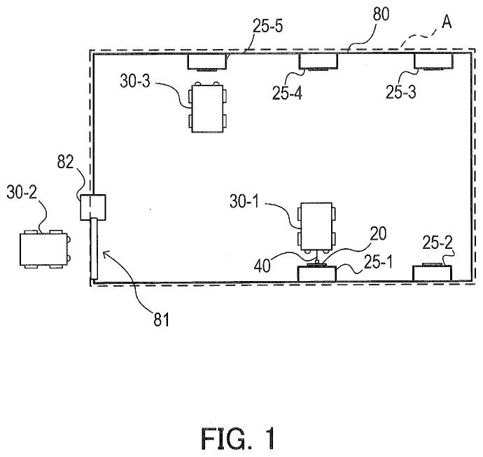

FIG. 1 is an explanatory diagram showing a disposing area in which an electrical outlet as an energy output section in a power-usage management system 10 according to the present embodiment 1 is disposed.

The disposing area A shown in FIG. 1 is a site of a parking place 80 having parking spaces in which a plurality of vehicles 30-1 to 30-3 can be parked. A location where the vehicles 30-1 to 30-3 can enter and exit the parking place 80 is one entrance/exit gate 81. A gate apparatus 82 is disposed at the entrance/exit gate 81 of the parking place 80. This gate apparatus 82 has a function of identifying and detecting vehicles 30 entering and exiting the parking place 80 (disposing area).

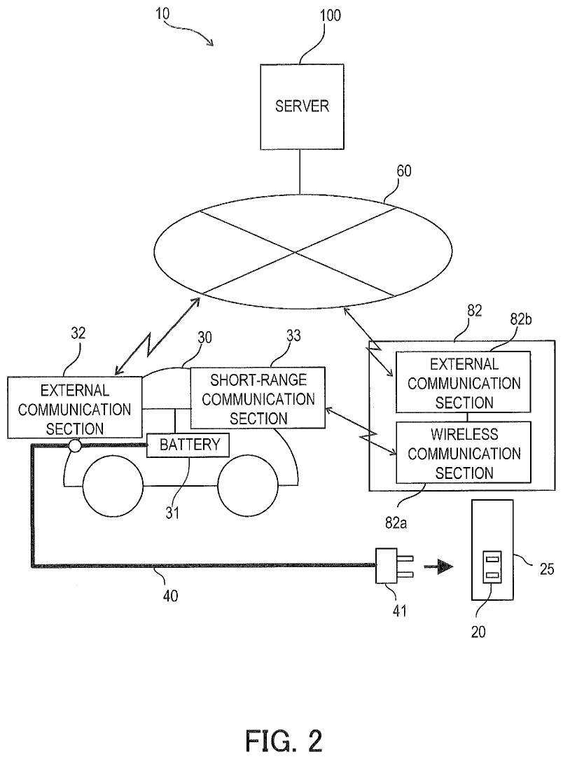

In the parking place 80, each of power-charging stands 25-1 to 25-5, which includes an electrical outlet 20, is disposed near the parking space. In the example of FIG. 1, although five power-charging stands 25-1 to 25-5 are disposed in the parking place 80, the number of power-charging stands disposed in the parking place is arbitrary, and may be one or more. It is noted that the disposing area A in the present embodiment 1 is outdoors, but may be indoors. FIG. 2 is an illustration showing an example of a schematic configuration of the power-usage management system 10 according to the present embodiment 1.

In FIG. 2, the power-usage management system 10 manages a provision and a use of an electric power to a supply target to which the electric power is supplied from the electrical outlet 20. The supply target in the present embodiment is the vehicle 30 or a battery 31 of the vehicle 30, which is charged by the electric power from the electrical outlet 20. The power supply from the electrical outlet 20 is performed via, for example, a wired power cable 40 and a plug 41. The power supply from the electrical outlet 20 may be performed by a wireless power supply such as a power supply by an electromagnetic induction, a radio wave such as a microwave, or the like, and a power supply by a light such as a laser light. Further, the voltage (current) supplied from the electrical outlet 20 may be alternating current or direct current.

The power-usage management system 10 includes a server 100 as an information processing apparatus that manages the provision and the usage of an electric power (electrical energy). The server 100 may be configured with a single computer apparatus, may be configured with a plurality of computer apparatuses cooperated with each other, or may be configured with a cloud system on a network.

The electrical outlet 20 as an energy output section capable of outputting an electric power (electrical energy) may be a general-purpose outlet with no limitation of use, or may be a dedicated outlet with a limitation of use. Further, the electrical outlet 20 may be an electrical outlet for which a user is not limited, or an electrical outlet that can be used only by a specific user.

The gate apparatus 82 disposed at the entrance/exit gate 81 of the parking place 80 includes a wireless communication section 82a capable of performing a short-range wireless communication such as a wireless LAN or Bluetooth (registered trademark) with a short-range communication section 33 mounted on the vehicle 30 passing through the entrance/exit gate 81. The wireless communication section 82a receives identification information for identifying the vehicle 30 or the user thereof from the short-range communication section 33 of the vehicle 30 passing through the entrance/exit gate 81. In the present embodiment 1, for example, vehicle identification information for identifying the vehicle 30 is transmitted from the short-range communication section 33 of the vehicle 30 to the wireless communication section 82a of the gate apparatus 82.

The gate apparatus 82 of the present embodiment 1 only needs to acquire identification information that can identify the vehicle 30 passing through the entrance/exit gate 81 or the user thereof. Therefore, a method of the acquisition is not limited to the method of receiving the identification information transmitted from the vehicle 30 by the wireless communication section 82a as described above. For example, a license plate (vehicle registration number certificate) of the vehicle 30 passing through the entrance/exit gate 81 is imaged using an imaging apparatus such as a camera, and the vehicle registration number of the vehicle 30 recognized from the obtained image is acquired as identification information. In addition, identification information of the vehicle received from an ETC (Electronic Toll Collection System) in-vehicle equipment installed in the vehicle may be used.

It is noted that, although the identification information of the vehicle 30 acquired by the gate apparatus 82 is eventually used for identifying the vehicle 30 in the server 100 of this system, it does not need to be the identification information itself used for processing in the server 100. That is, the identification information of the vehicle 30 acquired by the gate apparatus 82 may be identification information in a different format associated with the identification information used for processing in the server 100.

When the gate apparatus 82 acquires the identification information of the vehicle 30 passing through the entrance/exit gate 81, the external communication section 82b transmits the identification information to the server 100 via a communication network 60 such as a mobile communication network or the Internet. Herein, entering/exiting information for distinguishing between entering and exiting the parking place 80 and identification information (identification information of disposing area) for identifying the parking place 80 or the gate apparatus 82 are also transmitted. In the present embodiment 1, an example in which parking identification information for identifying the parking place 80 is used as the identification information of disposing area will be described.

The vehicle 30 can perform the short-range wireless communication with the wireless communication section 82a of the gate apparatus 82 by the short-range communication section 33 mounted on the vehicle, and communicate with the server 100 via the communication network 60 by the external communication section 32 mounted on the vehicle. The external communication section 32 and the short-range communication section 33 may be, for example, a remote control unit (TCU: Telematics Control Unit) connected to an in-vehicle network (CAN: Controller Area Network) via a gateway. The in-vehicle network (CAN) is connected to a battery management system (BMS) that manages the battery 31 and one or more electronic control units (ECU) that control other parts, in addition to the remote control unit (TCU).

Power usage information (for example, battery identification information, amount of electric power, power-charging start time, power-charging end time, etc.) regarding the electric power used for charging the battery 31 can be transmitted, for example, from the battery management system (BMS) to the server 100 via the remote control unit (TCU). Vehicle identification information can be transmitted, for example, from the electronic control unit (ECU) having a memory storing basic information of the vehicle, to the server 100 and the gate apparatus 82 via the remote control unit (TCU).

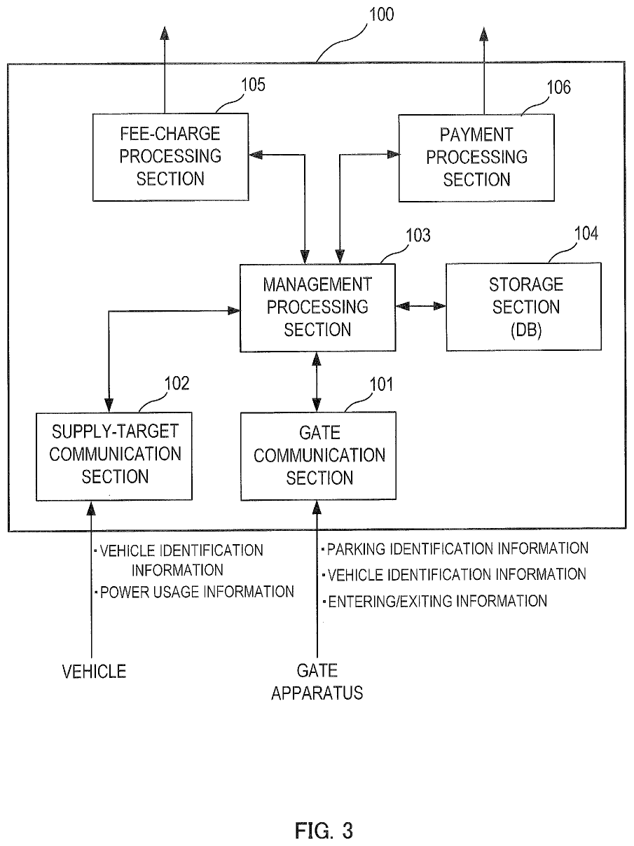

FIG. 3 is a block diagram showing an example of a configuration of main functions of the server 100 according to the embodiment 1. In FIG. 3, the server 100 includes a gate communication section 101, a supply-target communication section 102, a management processing section 103, a storage section (DB: database) 104, a fee-charge processing section 105, and a payment processing section 106.

The gate communication section 101 receives the parking identification information (identification information of disposing area) for identifying the parking place 80 from the gate apparatus 82 disposed in each parking place 80 (disposing area) via the communication network 60, as well as the vehicle identification information and the entering/exiting information of the vehicle 30 entering or exiting the parking place 80. The gate communication section 101 functions as a detection section, and by receiving such information, can detect the vehicle 30 that is the energy supply target existing inside the parking place, or the user, in each parking place 80 (disposing area).

The supply-target communication section 102 has a function as an information acquisition section, and receives, from the vehicle 30 that is the energy supply target, the vehicle identification information that is the identification information of the energy supply target and the power usage information (for example, battery identification information, amount of electric power, power-charging start time, power-charging end time) including information of the supply amount that is supplied from the electrical outlet 20 to the battery 31 of the vehicle 30.

In the present embodiment 1, in order to calculate a usage fee (fee to be charged to the user) and a provision fee (fee to be paid to a charging service business-operator) of the electric power related to charging from the electrical outlet 20, although the power usage information is received and acquired by the supply-target communication section 102, other acquisition methods may be used. For example, if the power usage information of the vehicle 30 is stored and managed in a vehicle management server of a vehicle manufacturer in association with the identification information of the vehicle 30, the power usage information may be acquired from the vehicle management server.

In addition, in order to calculate the usage fee and the provision fee of the electric power relating to the power-charging from the electrical outlet 20, it is necessary to grasp information (supply amount information) on the amount of electric power (power supply amount) supplied to the vehicle 30. For example, if the detection section provided on a side of the vehicle 30 or the electrical outlet 20 can directly detect the amount of electric power (power supply amount) charged to the battery 31 from the electrical outlet 20, the information on the detected amount of electric power can be used as the supply amount information.

Furthermore, for example, if the detection section provided on the vehicle 30 is capable of detecting a remaining power amount in the battery 31, information on the detected remaining power amount may be used as the supply amount information. In this case, for example, by subtracting the remaining power amount before charging from the remaining power amount after charging, it is possible to obtain the amount of electric power (power supply amount) charged to the battery 31 from the electrical outlet 20.

Moreover, since many electric vehicles are equipped with the detection section that detects a power-charging rate (SoC: State of Charge) of the battery 31, SoC data may be used as the supply amount information. In this case, unless a full charge capacity of the battery 31 is known, the remaining power amount of the battery 31 cannot be determined from the SoC data. However, by storing a correspondence relation between the identification information of the battery 31 and the full charge capacity in the storage section (DB) 104, the full charge capacity can be specified from the identification information of the battery 31, and the remaining power amount of the battery 31 can be calculated from the SoC data of the battery 31.

In the present embodiment 1, the gate communication section 101 and the supply-target communication section 102 may be configured as an integrally configured communication apparatus (for example, a mobile communication module).

The management processing section 103 performs various types of process such as an association process for associating the parking identification information that is the identification information of the disposing area, the vehicle identification information that is the identification information of the energy supply target, parking usage information, and the power usage information, an authentication process of the energy supply target (the vehicle 30 or the user thereof), a parking-usage management process for managing the parking usage information for each energy supply target, and a power-usage management process for managing the power usage information for each user or supply target.

As the association process in the present embodiment 1, the management processing section 103 registers the parking identification information, the vehicle identification information and the entering/exiting information received by the gate communication section 101 from the gate apparatus 82 at an area stay database in the storage section 104. Specifically, it determines whether the vehicle has entered or exited based on the entering/exiting information. For example, in the entering case, the vehicle identification information is associated with the parking identification information and registered in the area stay database together with an entering time, and in the exiting case, an existing time is associated with the vehicle identification information and registered in the area stay database. As a result, the vehicle identification information of all the vehicles 30 existing (staying) in each of the parking places 80, and the entering time and the exiting time of all the vehicles 30 existing (staying) in each of the parking place, in which the electrical outlets 20 managed by the server 100 is disposed, is registered in the area stay database.

Further, as authentication process in the present embodiment 1, the management processing section 103 performs a user authentication which confirms whether the user is an authorized regular user registered in advance in a target service of the present embodiment by comparing the vehicle identification information received by the supply-target communication section 102 from each vehicle 30 with the vehicle identification information registered in advance in the server 100. Specifically, a user registration database that associates identification information of the regular user with authorized vehicle identification information is stored in the storage section 104, and after confirming that the vehicle identification information received by the supply-target communication section 102 from each vehicle 30 is registered in the user registration database, it is determined that the user of the received vehicle identification information is the regular user. In the case of regular user, the usage of the service may be permitted, and in the case of non-regular user, the usage of the service may be restricted (for example, usage is not permitted).

Furthermore, in the parking place usage management process in the present embodiment 1, the management processing section 103 refers to the area stay database in the storage section 104, and registers stay time information regarding a time when the each vehicle 30 stayed in the parking place 80, in a parking-usage management database, in association with the vehicle identification information of the vehicle 30 (or the identification information of the user associated with the vehicle identification information).

Herein, the management processing section 103 refers to the area stay database in the storage section 104, confirms in which parking place 80 the vehicle 30 corresponding to the vehicle identification information exists (stays), and acquires a parking-place identification information of the confirmed parking place 80. Then, the management processing section 103 refers to a business-operator database in the storage section 104, confirms which business-operator is a parking place manager (provider) corresponding to the parking-place identification information, acquires a business-operator identification information of the confirmed parking place manager, and registers the acquired business-operator identification information in the parking-usage management database together with the stay time information of the vehicle 30.

As the power-usage management process in the present embodiment 1, the management processing section 103 registers the power usage information and the vehicle identification information, which are received by the supply-target communication section 102 from each vehicle 30, in the power-usage management database in the storage section 104. Specifically, a power amount information (supply amount information) included in the power usage information received from each vehicle 30 is associated with the vehicle identification information of the vehicle 30 (or the user identification information associated with the vehicle identification information), and registered in the power-usage management database.

Herein, the management processing section 103 refers to the area stay database in the storage section 104 and confirms in which parking place 80 the vehicle 30 corresponding to the vehicle identification information exists (stays), and then acquires the parking identification information of the confirmed parking place 80. Then, the management processing section 103 refers to the business-operator database in the storage section 104 and confirms which charging service business-operator corresponds to the parking identification information, and then acquires the business-operator identification information of the confirmed charging service business-operator and registers this business-operator identification information in the power-usage management database together with the power amount information (supply amount information) included in the power usage information received from the vehicle 30.

The business-operator database stored in the storage section 104 of the present embodiment 1 stores the parking identification information for identifying each parking place 80 in association with the parking place manager as the provider that provides a time-rental parking service and the power-usage management service by using the electrical outlets 20, in each parking place 80. The system of the present embodiment 1 is a system in which the parking places 80 coexist, which are respectively managed by a plurality of the parking place managers. In the system of the present embodiment 1, the usage fee of a power usage by the vehicle 30 via the electrical outlet 20 is fee-charged to the user. Herein, when power-charging the vehicle 30 by supplying the electric power from the electrical outlet 20, it is conventionally usual that the usage fee charged to the user has conventionally been calculated based only on the amount of electric power (power supply amount) supplied during the charging. However, such a calculation method of the usage fee may cause a problem that an inequality in usage fees arises among users.

For example, some of the electrical outlets 20 coexist in the system of the present embodiment 1, which have different power supply speeds (power supply amount per unit time) to the vehicle 30. That is, some electrical outlets 20 are capable of a fast-charging in which a power supply speed is faster than other electrical outlets 20. There is also an added value of a direct current charging or an alternating current charging. In this case, with the above calculation method of the usage fee, a user who use a power charging by the fast-charging can obtain the power supply in a shorter time than another user who use a power charge by a slow-charging that is not fast-charging, and receive a benefit in which the power-charging completes in a shorter time. Therefore, if the usage fees are calculated based only on the power supply amount without taking into account a difference in the power supply speed, an inequality arises between the user who receive this benefit and the user who does not receive the benefit.

On the other hand, even in the parking place manager who is a provider of a power supply service (electrical charging service) from the electrical outlet 20, if the provision fee of the electrical charging service paid to the parking place manager is calculated based only on the power supply amount, an inequality arises among parking place managers.

Specifically, in the present embodiment 1, a management business-operator that manages the server 100 collects (fee-charges) the usage fees from users who use the power charge by receiving the power supply from the electrical outlets 20 in each parking place 80 (disposing area) in the present system 10. Then, the management business-operator of the server 100 distributes the usage fee collected from the users and pays the provision fee of the power supply service (electrical charging service) from the electrical outlet 20 according to the amount of electric power supplied from each electrical outlet 20, to the parking place manager of each parking place 80 in present system 10.

Herein, for example, a case is considered in which the present system 10 includes the electrical outlet 20 capable of the fast-charging that have the power supply speed faster than other electrical outlets 20, as described above. Such an electrical outlet 20 capable of performing the fast-charging is usually more expensive to dispose in the parking place 80 than other electrical outlets (electrical outlets that cannot perform the fast-charge). Furthermore, even if the electrical outlet is the same, similar differences occur if the amount of electric power is controlled on a supply side. Therefore, if the provision fee is calculated based only on the power supply amount without taking into account the differences in the power supply speeds, a difference in profits occurs and an inequality occurs between the parking place manager of the electrical outlet 20 capable of the fast-charging, who has invested an expensive facility, and the parking place manager of the electrical outlet 20 of the slow-charging that requires little investment.

Therefore, in the power usage management process in the present embodiment 1, when the electric power is supplied from the electrical outlet 20 of the parking place manager to the vehicle 30 of the user, not only the supplied amount of electric power when supplying the power but also the power supply speed when supplying the power is taken into consideration, and then the usage fee to be charged to the user is calculated. As a result, it is possible to correct the inequality between the users due to differences in the power supply speeds, and it is possible to provide the electrical charging service that gives a sense of equality to the users.

In the power usage management process in the present embodiment 1, when the electric power is supplied from the electrical outlet 20 of the parking place manager to the vehicle 30 of the user, not only the supplied amount of electric power when supplying the power but also the power supply speed when supplying the power is taken into consideration, and then the provision fee to be paid to the parking place manager is calculated. As a result, it is possible to correct the inequality between the parking place managers due to differences in the power supply speeds, and it is possible to provide the electrical charging service that gives a sense of equality to the parking place managers. Particularly, it is possible to create a way for appropriately recovering the investment for the parking place manager who has invested the expensive facility for the electrical outlet 20 that is capable of the fast-charging.

It is noted that, in the present embodiment 1, the power supply speed of each electrical outlet 20 is approximately constant at a predetermined speed depending on the respective configuration, so the difference in the power supply speed when the electric power is supplied from each electrical outlet 20 can be associated with each electrical outlet 20 in advance based on, for example, a request from a parking place manager. Therefore, in the present embodiment 1, information of the power supply speed (for example, information that distinguishes between fast-charging and slow-charging) of the electrical outlet 20 disposed in the parking place 80 is stored in the business-operator database in the storage section 104 in association with the parking-place identification information for identifying the parking place 80. Thereby, the system of the present embodiment 1 can grasp the power supply speed when the electric power is supplied from each electrical outlet 20.

It is noted that there may be cases where there are electrical outlets 20 whose power supply speeds are not constant. For example, there may be a mixture of electrical outlets whose power supply speed is variable according to predetermined conditions and electrical outlets whose supply speed can be selected by the user. Additionally, in order to avoid a short-term overload on the electrical outlet side, there may be also electrical outlets that is controlled to temporarily reduce the power supply speed or stop the power supply for a certain period of time (set the power supply speed to zero). In such a case, the server 100 acquires information of the power supply speed when the electric power is supplied from the electrical outlet. For example, the server 100 may acquire information on the power supply speed transmitted from the external communication section 32 installed in the vehicle 30, the communication apparatus provided in the electrical outlet 20, or the terminal apparatus owned by the user.

Furthermore, the power supply speed may also vary depending on the difference in a configuration of the vehicle 30 and battery 31 as the supply target. Specifically, the power supply speed may vary depending on an AC power consumption rate (power consumption) of the vehicle, a battery capacity, a remaining battery level, a degree of battery deterioration (mileage of the vehicle 30, usage time of the battery 31, etc.), a charging efficiency, a location of the vehicle (region where the vehicle 30 is charged), the remaining amount of gasoline for plug-in hybrid vehicles, etc. Therefore, such information may be acquired to figure out the difference in the power supply speed, and then the usage fee to be fee-charged to the user and the provision fee to be paid to the parking place manager may be calculated. It is noted that such information can be obtained, for example, by acquiring information on the type of the vehicle 30 (energy supply target), which will be described later.

Further, some electrical outlets 20 in the system of the present embodiment 1 have for example, different types of output power (energy) generation methods. These types include, for example, a type recommended by a national energy policy, a type with low generation cost, and the like. Thus, when there are different types of the output power (energy) generation methods, the above calculation method of the usage fee may cause an inequality between the user who charges the electric power generated by a specific type and the user who charges the electric power generated by another type.

On the other hand, even in the parking place manager who is the provider of the power supply service (electrical charging service) from the electrical outlet 20, if the provision fee of the electrical charging service paid to the parking place manager is calculated based only on the power supply amount, an inequality occurs between the parking place manager who provides the electric power generated by a specific type and the parking place manager who provides the electric power generated by another type.

It is noted that a specific example of the type of the output power (energy) generation method includes a method type capable of being distinguished as being a type in which a power source for generating the electric power is of a type of power source that generates the electric power from a fossil fuel such as an oil or a coal, or a method type in which a power source for generating the electric power is of a type of power source that generates the electric power from a natural energy such as a wind power, sunlight or a biomass (biological resource). It may be a method type capable of being distinguished as being a method type in which the foregoing type of the fossil fuel or the natural energy is further differentiated in detail (for example, in a case of the natural energy, a method type in which the wind power, the sunlight, and the biomass (biological resource) can be differentiated). The type may be determined, for example, based on the presence or absence of a certificate (such as a Green Power Certificate) issued by a predetermined certification authority.

The type of the output power (energy) generation method is not limited to the type of the power source as described above, and includes all types of generation methods that may cause an inequality among the users or the parking place managers, such as a method in which the amount of CO₂ (carbon dioxide) generated in a power generation process is differentiated.

In the power usage management process in the present embodiment 1, when the electric power is supplied from the electrical outlet 20 of the parking place manager to the vehicle 30 of the user, not only the amount of electric power supplied at that time but also the generation method type of the supplied electric power is taken into consideration, and then the usage fee to be charged to the user is calculated. As a result, it is possible to correct the inequality among the users due to differences in the generation method types of the electric power, and it is possible to provide the electrical charging service that gives a sense of equality to the users.

In the power usage management process in the present embodiment 1, when the electric power is supplied from the electrical outlet 20 of the parking place manager to the vehicle 30 of the user, not only the amount of electric power supplied at that time but also the generation method type of the supplied electric power is taken into consideration, and then the provision fee to be paid to the parking place manager is calculated. As a result, it is possible to correct the inequality among the parking place managers due to differences in the generation method types of the electric power, and it is possible to provide the electrical charging service that gives a sense of equality to the parking place managers.

It is noted that, in the present embodiment 1, the type of the power generation method corresponding to each electrical outlet 20 may be associated with each electrical outlet 20 in advance, for example, based on a request from the parking place manager. Therefore, in the present embodiment, in the business-operator database in a storage section 104, information on the type of the power generation method (for example, information on the presence or absence of the Green Power Certificate) corresponding to the electrical outlet 20 disposed in parking place 80 is stored corresponding to the parking-place identification information for identifying the parking place 80. Thereby, the system of the present embodiment 1 can grasp the type of generation method of electric power supplied from each electrical outlet 20.

There may be a case that the electrical outlets 20 in the system of the present embodiment 1 may be, for example, of different types in which the type of vehicle 30 (energy supply target) to which the output electric power is supplied is different from each other. This vehicle type includes, for example, a manufacturer and a model of the vehicle 30, or a manufacturer and a model of the battery 31 installed in the vehicle 30. Thus, when the types of vehicles 30 are different from each other, the power supply speed may be different, and a cost for the power supply may be different. Therefore, when the types of the vehicles 30 or the batteries 31 of the users are different from each other, the above calculation method of the usage fee may cause an inequality between the user who receives the power supply to the vehicle 30 of a specific type and the user who receives the power supply to the vehicle 30 of another type.

On the other hand, even in the parking place manager who is the provider of the power supply service (electrical charging service) from the electrical outlet 20, if the provision fee of the electrical charging service, which is paid to the parking place manager, is calculated based only on the power supply amount, an inequality occurs between the parking place manager who provides the electric power to the vehicle 30 of a specific type and the parking place manager who provides the electric power to the vehicle 30 of other type.

In the power usage management process in the present embodiment 1, when the electric power is supplied from the electrical outlet 20 of the parking place manager to the vehicle 30 of the user, not only the amount of electric power supplied at that time but also the types of the vehicles 30 (energy supply target) supplied the electric power is taken into consideration, and then the usage fee to be charged to the user is calculated. As a result, it is possible to correct the inequality among the users due to differences in the types of energy supply targets, and it is possible to provide the electrical charging service that gives a sense of equality to the users. In the power usage management process in the present embodiment 1, when the electric power is supplied from the electrical outlet 20 of the parking place manager to the vehicle 30 of the user, not only the amount of electric power supplied at that time but also the types of the vehicles 30 (energy supply target) supplied the electric power is taken into consideration, and then the provision fee to be paid to the parking place manager is calculated. As a result, it is possible to correct the inequality among the parking place managers due to differences in the types of energy supply targets, and it is possible to provide the electrical charging service that gives a sense of equality to the parking place managers.

In the present embodiment 1, the type of vehicle 30 that receives the power supply from each electrical outlet 20 can be determined by the server 100 based on the vehicle identification information of the vehicle 30 transmitted from the external communication section 32 of the vehicle 30.

In the present embodiment 1, the fee-charge processing section 105 performs a process necessary for fee-charging the usage fee of the electric power used by the vehicle 30 via the electrical outlet 20, to the user. Specifically, the fee-charge processing section 105 refers to the power-usage management database in the storage section 104, and acquires the user identification information of the user, the power usage information (supply amount information, etc.) associated with this user, and a vehicle type information (information on the type of vehicle 30) of the vehicle 30 that receives the power supply, which is associated with this user. Additionally, the fee-charge processing section 105 refers to the business-operator database in the storage section 104, and acquires information on the power supply speed corresponding to the electrical outlet 20 and information on the type of generation method of the electric power supplied from the electrical outlet 20. Then, the fee-charge processing section 105 calculates the usage fee of the electrical charging service for each user based on the above information, and performs a process necessary for fee-charging the calculated usage fee.

In the present embodiment 1, the payment processing section 106 performs a process necessary for paying the provision fee of the electrical charging service to the parking place manager who is the provider of the electrical charging service. Specifically, the payment processing section 106 refers to the power-usage management database in the storage section 104, and acquires the power usage information of each user associated with the business-operator identification information of the parking place operator and the vehicle type information (information on the type of vehicle 30) of the vehicle 30 that receives the power supply. Additionally, the payment processing section 106 refers to the business-operator database in the storage section 104, and acquires information on the power supply speed corresponding to the electrical outlet 20 of the parking place manager and information on the generation method of the electric power supplied from the electrical outlet 20. Then, the payment processing section 106 calculates the provision fee of the electrical charging service for each parking place manager based on the above information, and performs a process necessary for paying the calculated provision of the electrical charging service to the parking place manager.

In the present embodiment 1, the payment processing section 106 also performs a process necessary for paying a provision fee for providing a parking service to the parking place manager that provides the parking service. Specifically, in the parking-usage management database in the storage section 104, the stay time information of each vehicle associated with the business-operator identification information of the parking place manager is extracted, and the provision fee according to the stay time information is calculated for each parking service business-operator. Then, the payment processing section 106 performs a process necessary for paying the calculated provision fee to the corresponding parking service business-operator. The provision fee of the parking service may be added to the provision fee of the electrical charging service described above.

It is noted that, in the present embodiment 1, although the management business-operator of the server 100 performs the process for fee-charging the usage fee of the parking service and the electrical charging service, to the user, and the process for paying the provision fee of the parking service and the electrical charging service, to each provision business-operator, at least one of the processes may be performed by another business-operator. Specifically, when the former process is performed by another business-operator, the fee-charge processing section 105 of the server 100 performs a process for calculating the usage fee for the parking service and the electrical charging service and providing the calculated usage fee to the other business-operator, as the process necessary for fee-charging. In addition, when the latter process is performed by another business-operator, the payment processing section 106 of the server 100 performs a process for calculating the respective provision fees for the parking service and the electrical charging service and providing the calculated usage fee and the provision business-operator of payee, to the other business-operator, as the process necessary for payment.

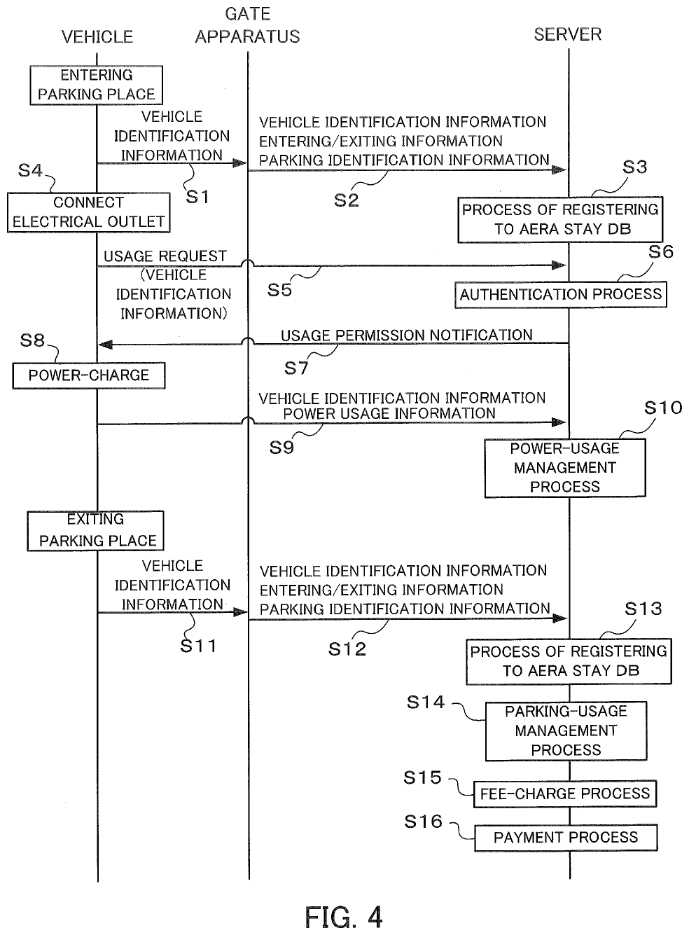

FIG. 4 is a sequence diagram showing an example of process in the power-usage management system 10 of the present embodiment 1.

In the storage section 104 of the server 100, a data input to the user registration database is performed in advance by an operator or the like, and then the storage section 104 stores the identification information of the authorized regular users, the vehicle identification information of the vehicles used by the users and information on the type of the vehicles, in association with each other. Further, in the storage section 104 of the server 100, a data input to the business-operator database is performed in advance by an operator or the like, and then the storage section 104 stores identification information of the parking place managers, the parking identification information of the parking places 80 managed by the parking place manager, the information on the power supply speed (for example, information that distinguishes between fast-charging and slow-charging) of the electrical outlets 20 disposed in the parking places 80, and the information on the type of the power generation method (for example, information on the presence or absence of the Green Power Certificate) corresponding to the electrical outlet 20 disposed in parking place 80, in association with each other.

When the vehicle 30 enters the parking place 80 through the entrance/exit gate 81 of the parking place 80, the gate apparatus 82 communicates with the short-range communication section 33 of the vehicle 30 by the wireless communication section 82a to receive the vehicle identification information of the vehicle 30 from the vehicle 30 (S1). Then, the gate apparatus 82 transmits the received vehicle identification information to the server 100 via the communication network 60 together with the entering/exiting information at the time of entering and the parking identification information of the parking place 80 by the external communication section 82b (S2).

The management processing section 103 of the server 100 registers the vehicle identification information, the entering/exiting information and the parking identification information received from the gate apparatus 82 by the gate communication section 101 in the area stay database in the storage section 104. Here, since the entering/exiting information indicates the time of entering, the vehicle identification information is registered in the area stay database in association with the parking identification information together with the entering/exiting information at the time of entering (S3).

Subsequently, when the vehicle 30 is parked at the parking space in the parking place 80 and receives electric power from the electrical outlet 20 of the power-charging stand 25 to charge the battery 31, a plug 41 of a power cable 40 of the vehicle 30 is connected to the electrical outlet 20 (S4). As a result, a usage request including the vehicle identification information of the vehicle 30 is transmitted from the external communication section 32 of the vehicle 30 to the server 100 via the communication network 60 (S5).

When this usage request is received by the supply-target communication section 102 of the server 100, an authentication process is executed in the management processing section 103 (S6). In this authentication process, it is confirmed whether or not the vehicle identification information included in the usage request belongs to the regular users registered in the user registration database in storage section 104.

If it is confirmed that the user is the regular user by the above authentication process, the server 100 outputs a usage permission notification to the vehicle 30, which is the transmission source of the usage request, through the communication network 60 by the supply-target communication section 102 (S7). The vehicle 30, which received this usage permission notification, starts a power supply to the battery 31 from the electrical outlet 20 to which the plug 41 is connected, by the battery management system (BMS), thereby charges the battery 31 (S8).

If it is not possible to confirm that the user is the regular user, the server 100 outputs a usage non-permission notification to the vehicle 30 that is the transmission source of the usage request, through the communication network 60 by the supply-target communication section 102. In this case, the power-usage management service using the electrical outlet 20 may be disabled.

The battery management system (BMS) of the vehicle 30 generates the power usage information (amount of electric power, power-charging start time, power-charging end time, etc.) related to the electric power used to charge the battery 31. After the power-charging is completed, the power usage information and the vehicle identification information are transmitted from the external communication section 32 of the vehicle 30 to the server 100 via the communication network 60 (S9). When this power usage information and the vehicle identification information are received by the supply-target communication section 102 of the server 100, the management processing section 103 executes the power-usage management process for registering the received power usage information and the vehicle identification information in the power-usage management database in the storage section 104 (S10).

In the power-usage management process of the present embodiment 1, for the fee-charge process, at least the power amount information included in the power usage information received from the vehicle 30 is registered in the power-usage management database together with the vehicle identification information of the vehicle 30 and the business-operator identification information corresponding to the parking identification information of the parking place in which the vehicle 30 exists.

On the other hand, when the vehicle 30 exits the parking place 80 from the entrance/exit gate 81 of the parking place 80, the gate apparatus 82 communicates with the short-range communication section 33 of the vehicle 30 by the wireless communication section 82a to receive the vehicle identification information of the vehicle 30 from the vehicle 30 (S11). Then, the gate apparatus 82 transmits the received vehicle identification information to the server 100 via the communication network 60 together with the entering/exiting information at the time of exiting and the parking identification information of the parking place 80 by the external communication section 82b (S12). Then, the management processing section 103 of the server 100 registers the vehicle identification information, the entering/exiting information and the parking identification information, which are received from the gate apparatus 82 by the gate communication section 101, in the area stay database in the storage section 104. Herein, since the entering/exiting information indicates the timing of exiting, the entering/exiting information at the time of exiting is registered in the area stay database in association with the parking identification information and the vehicle identification information (S13).

Next, the management processing section 103 refers to the area stay database in the storage section 104, and performs the parking-usage management process that registers the stay time information regarding the time that the vehicle 30 stays in the parking place 80 in the parking-usage management database in association with the vehicle identification information of the vehicle 30 (S14).

Thereafter, the fee-charge processing section 105 of the server 100 performs a process necessary for charging the usage fee of the parking service and the electric charging service for the current vehicle 30, to the use corresponding to the vehicle 30 (S15). Specifically, it performs a process for adding the usage fee of electrical charging service, which is calculated with reference to the power-usage management database in the storage section 104, and the usage fee of parking service, which is calculated with reference to the parking-usage management database in the storage section 104 are added together, and charging the added fee to each user.

Furthermore, the payment processing section 106 of the server 100 performs a process necessary for paying the provision fee of the parking service and the provision fee of the electric charging service for the current vehicle 30, to the provision business-operators of the respective services (S16). Specifically, it performs a process for calculating the provision fee of electrical charging service of each charging service business-operator with reference to the power-usage management database in the storage section 104, calculating the provision fee of parking service of each parking service business-operator with reference to the parking-usage management database in the storage section 104, and paying the calculated provision fees to each provision business-operator.

### Embodiment 2

Next, another embodiment of the present invention (hereinafter, this embodiment will be referred to as “embodiment 2”) is described.

In the above-described embodiment 1, the vehicle identification information of the vehicles 30 existing (staying) in the parking place 80 (disposing area A) is managed in the area stay database by using the gate apparatus 82 disposed in the entrance/exit gate 81 of the parking place 80. However, in a case such that the electrical outlet 20 of the power-charging stand 25 is disposed in a place that is not physically partitioned, the entrance/exit point is not limited, thereby in a configuration such that the gate apparatus 82 identifies and detects the vehicle 30 passing through the entrance/exit, the vehicle identification information of the vehicles 30 existing in the parking place 80 cannot be managed by the area stay database.

Therefore, in the present embodiment 2, the vehicle identification information of the vehicles 30 existing in the parking place 80 as disposing area of the electrical outlet 20 is managed in the area stay database by a configuration different from that of the present embodiment 1 described above. Specifically, a geofence technology is used to set a virtual disposing area. The geofence technology is a technology that establishes a virtual boundary line on the ground and grasps communication terminals entering and exiting the disposing area partitioned by the boundary line. That is, in the present embodiment 2, the vehicle 30 existing in each disposing area is detected based on a position information of the vehicle 30 and a position information of the disposing area.

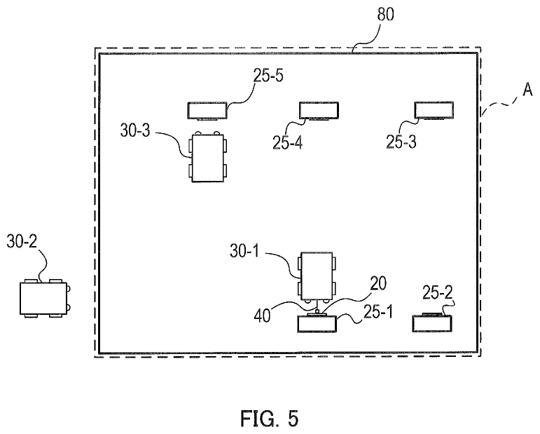

FIG. 5 is an explanatory diagram showing the disposing area in which the electrical outlets 20 configuring the power-usage management system according to the present embodiment 2 is disposed.

In the present embodiment 2, as shown in FIG. 5, the site of the parking place 80 disposed the electrical outlet is set as geofence area A.

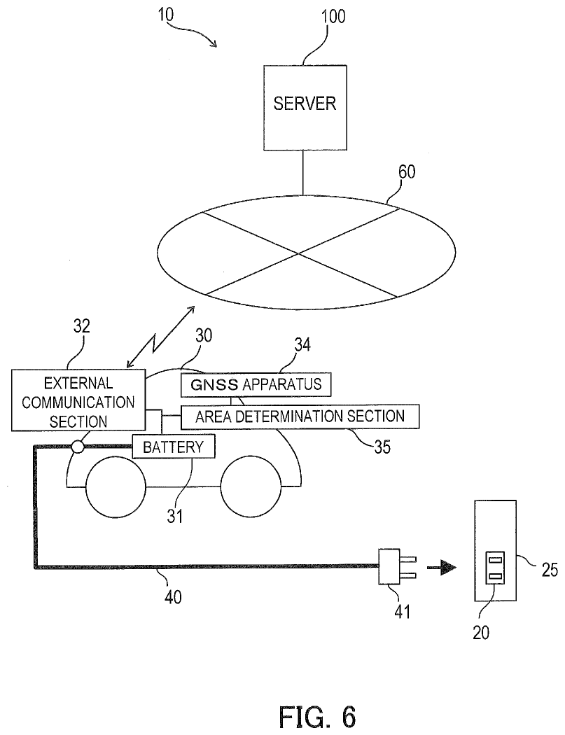

FIG. 6 is an explanatory diagram showing an example of the schematic configuration of the power-usage management system 10 according to the present embodiment 2.

Each vehicle 30 is respectively equipped with a GNSS (Global Navigation Satellite System) apparatus 34, and can acquire positioning results obtained by positioning with the GNSS apparatus 34 as the position information. In addition, each vehicle 30 is provided with an area determination section 35 which determines whether or not it has entered in or exited from the disposing area (each geofence area) A set in advance, based on the positioning result (position information) obtained by positioning with the GNSS apparatus 34 provided by itself. In the area determination section 35, the position information of the disposing area A set in advance is registered beforehand. The position information of the disposing area A, for example, may be received by the external communication section 32 from the server 100 via the communication network 60 and registered at a predetermined timing.

When the area determination section 35 of each vehicle 30 determines that it has entered the disposing area A based on the position information of the disposing area A and the positioning results (position information) obtained by the GNSS apparatus 34, it transmits an area entering notification including area identification information (identification information of the disposing area) for specifying the entered disposing area to the server 100. Also, when it determines that it has exited the disposing area A, it transmits an area exiting notification including the area identification information for specifying the exited disposing area to the server 100.

It is noted that although each vehicle 30 is provided with the area determination section 35 in the present embodiment 2, the server 100 may have a function of the area determination section 35.

As in the present embodiment 2, by using the disposing area partitioned by the virtual boundary line such as the geofence, even in the case where the electrical outlet 20 of the power-charging stand 25 is disposed in the disposing area that is not physically partitioned, the vehicles 30 existing in the disposing area can be grasped, and the vehicle identification information of the vehicles 30 existing in the disposing area can be managed by the area stay database.

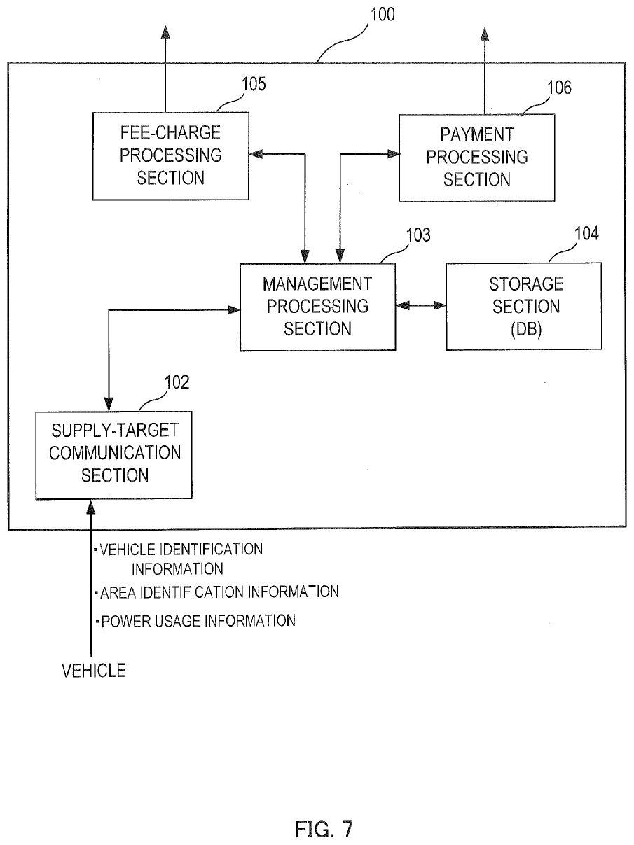

FIG. 7 is a block diagram showing an example of the configuration of main functions of the server 100 according to the embodiment 2.

In FIG. 7, although the server 100 of the present embodiment 2 does not need to communicate with the gate apparatus 82 and so it does not include the gate communication section 101, other configurations are the same as those of the embodiment 1 as described above.

In the system of the present embodiment 2, a process of detecting the vehicle 30 existing in the disposing area can be realized by communication between the vehicle 30 and the server 100, thereby there is no need for communication between the gate apparatus 82 and the server 100, so the equipment load, etc. can be reduced.

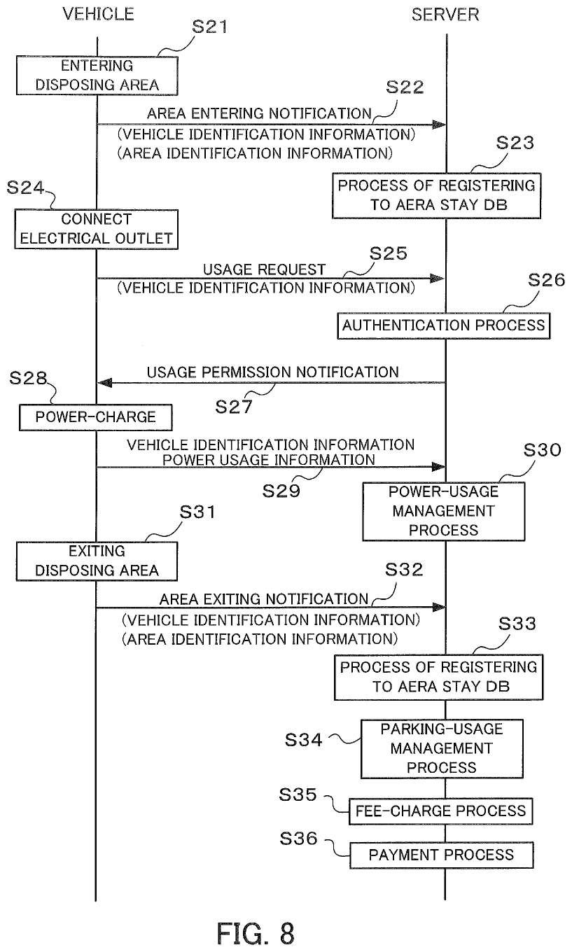

FIG. 8 is a sequence diagram showing an example of the power-usage management process in the embodiment 2.

When the vehicle 30 enters the parking place 80, the area determination section 35 of the vehicle 30 determines that it has entered the disposing area based on the position information of the disposing area A corresponding to the site of the parking place 80 and the positioning result (position information) obtained by the GNSS apparatus 34 (S21). Then, from the external communication section 32 of the vehicle 30, an area entering notification including area identification information (identification information of the disposing area) for specifying the entered disposing area and the vehicle identification information of the vehicle 30 is transmitted to the server 100 via the communication network 60 (S22).

The management processing section 103 of the server 100 registers the vehicle identification information and the area identification information received from the vehicle 30 by the supply-target communication section 102 in the area stay database in the storage section 104. Here, since the vehicle has entered the disposing area, the vehicle identification information is registered in the area stay database in association with the area identification information together with the entering/exiting information at the time of entering (S23).

Subsequently, when the vehicle 30 parks at the parking space in the parking place 80, and receives electric power from the electrical outlet 20 of the power-charging stand 25 in the parking place 80 to charge the battery 31, the plug 41 of the power cable 40 of the vehicle 30 is connected to the electrical outlet 20 (S24). As a result, a usage request including the vehicle identification information of the vehicle 30 is transmitted from the external communication section 32 of the vehicle 30 to the server 100 via the communication network 60 (S25). When this usage request is received by the supply-target communication section 102 of the server 100, the management processing section 103 executes authentication process similar to that of the embodiment 1 described above (S26).

If it is confirmed that the user is the regular user by the authentication process, the server 100 outputs a usage permission notification to the vehicle 30, which is the transmission source of the usage request, through the communication network 60 by the supply-target communication section 102 (S27). The vehicle 30 received this usage permission notification starts power supply from the electrical outlet 20 to which the plug 41 is connected to the battery 31 by the battery management system (BMS), thereby charging the battery 31 (S28).

After the power-charging is completed, as in the embodiment 1 described above, the power usage information is transmitted from the external communication section 32 of the vehicle 30 to the server 100 via the communication network 60 (S29). When this power usage information is received by the supply-target communication section 102 of the server 100, as in the embodiment 1 described above, the management processing section 103 executes the power-usage management process for registering the received power usage information in the power-usage management database in the storage section 104 (S30).

On the other hand, when the vehicle 30 exits the parking place 80, the area determination section 35 of the vehicle 30 determines that it has exited the disposing area based on the position information of the disposing area B1 or B2 corresponding to the site of the parking place 80 and the positioning result (position information) obtained by the GNSS apparatus 34 (S31). Then, from the external communication section 32 of the vehicle 30, an area exiting notification including the area identification information (identification information of the disposing area) for specifying the exited disposing area and the vehicle identification information of the vehicle 30 is transmitted to the server 100 via the communication network 60 (S32). Then, the management processing section 103 of the server 100 registers the vehicle identification information and the area identification information received from the vehicle 30 by the supply-target communication section 102 from the area stay database in the storage section 104. Here, since the entering/exiting information indicates the time of exiting, the entering/exiting information at the time of exiting is registered in the area stay database in association with the vehicle identification information and the area identification information (S33).

Next, as in the embodiment 1 described above, the management processing section 103 refers to the area stay database in the storage section 104, and performs the parking-usage management process that registers the stay time information regarding the time that the vehicle 30 stays in the parking place 80 in the parking-usage management database in association with the vehicle identification information of the vehicle 30 (S34). Thereafter, the fee-charge processing section 105 and the payment processing section 106 of the server 100 perform the same process as in the embodiment 1 described above (S35, S36).

As described above, in the systems of the above-mentioned embodiment 1 and 2, when the fee-charge processing section 105 of the server 100 calculates the usage fee charged to the user of the electrical charging service, the usage fee is calculated based on, not only information on the power supply amount (energy supply amount), but also at least one of information on the power supply speed at the time of the power supply, information on the type of generation method of electric power received by the power supply, and information on the type of the vehicle 30 (energy supply target) receiving the power supply. According to this, the usage fee of the electrical charging service includes a fee according to the power supply amount (energy supply amount), a fee for an added value of high-speed power supply (fast-charging) at the time of the power supply, a fee according to the type of generation method of electric power received by the power supply, and a fee according to the type of the vehicle 30 (energy supply target) receiving the power supply, thereby it is possible to perform a multi-dimensional fee-charging, that is, more detailed fee-charging, and inequality among users can be corrected. It is noted that “multi-dimensional fee-charging” herein means a method of calculating a charged fee of the electrical charging service by using a plurality of linearly independent variables or non-independent variables.

Furthermore, in the systems of the above-mentioned embodiment 1 and 2, when the payment processing section 106 of the server 100 calculates the provision fee paid to the parking manager as the provider of electrical charging service, the provision fee is calculated based on, not only information on the power supply amount (energy supply amount), but also at least one of information on the power supply speed at the time of the power supply, information on the type of generation method of electric power received by the power supply, and information on the type of the vehicle 30 (energy supply target) receiving the power supply. According to this, the provision fee of the electrical charging service includes a fee according to the power supply amount (energy supply amount), a fee for an added value of high-speed power supply (fast-charging) at the power supply, a fee according to the type of generation method of electric power received by the power supply, and a fee according to the type of the vehicle 30 (energy supply target) receiving the power supply, thereby it is possible to perform a multi-dimensional payment of provision fee, that is, more detailed payment of the provision fee, and inequality among parking managers can be corrected. It is noted that “multi-dimensional payment of provision fee” herein means a method of calculating the provision fee of the electrical charging service by using a plurality of linearly independent variables or non-independent variables.

It is noted that, in the embodiment 1 and 2 described above, although a communication between the vehicle 30 and the server 100 is performed by using the external communication section 32 mounted on the vehicle 30, instead of such an external communication section 32 mounted on the vehicle, a terminal apparatus owned by the user may be used. As the terminal apparatus, for example, a mobile station (also referred to as a “mobile device”, a “user equipment (UE)”, etc.) capable of communicating via a mobile communication network of the fourth generation or the fifth generation or the later generation is used.

When the terminal apparatus possessed by the user is used instead of the external communication section 32 mounted on the vehicle, a user ID or the like used in an application running on the terminal apparatus can be used as identification information of the energy supply target instead of the vehicle identification information. In case of using the terminal apparatus, as the identification information of disposing area, although for example, the positioning result (position information) obtained by positioning with the GNSS apparatus installed in the terminal apparatus can be used, other information may be used. For example, an imaging apparatus (camera) installed in the terminal apparatus reads the QR code (registered trademark) displayed near the electrical outlet 20 used for charging (power-charging stand 25 of the electrical outlet 20), and identification information included in this QR code (registered trademark) can be used as the identification information of the disposing area.

Also, when the terminal apparatus is used, the terminal apparatus needs to acquire the power usage information and the like from the side of the vehicle 30. In this case, for example, the transmission request generated by an application running on the terminal apparatus 51 is transmitted to the remote control unit (TCU) of the vehicle via short-range wireless communication, and is acquired from the remote control unit (TCU).

It is noted that process steps and configuration elements such as information processing apparatuses, gate apparatuses, in-vehicle apparatuses of vehicles, and terminal apparatuses described in the present specification can be implemented with various means. For example, these process steps and configuration elements may be implemented with hardware, firmware, software, or a combination thereof.

With respect to hardware implementation, means such as processing sections or the like used for establishing the foregoing steps and configuration elements in entities (for example, computer apparatus, server, gate apparatus, in-vehicle apparatus of vehicle, terminal apparatus (user equipment, mobile station, communication terminal), hard disk drive apparatus, or optical disk drive apparatus) may be implemented in one or more of an application-specific IC (ASIC), a digital signal processor (DSP), a digital signal processing device (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing sections or the like for using to establish the foregoing configuration elements may be implemented with a program (for example, a code such as a procedure, a function, a module, an instruction, etc.) for performing a function described in the present specification. In general, any computer/processor readable medium of clearly materializing the code of firmware and/or software may be used for implementation of means such as processing sections and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage section, or the like. The code may be executed by one or more of computers and processors, and a certain aspect of functionalities described in the present specification may be executed by a computer or processor.

The foregoing medium may be a non-temporary recording medium. The foregoing code of the program may be readable and executable by a computer, processor, or other device or apparatus machine, and its format is not limited to a specific format. For example, the foregoing code of the program may be any of source code, object code, and binary code, or may be a mixture of two or more of these codes.

The description of embodiments disclosed in the present specification is provided so that the present disclosures can be produced or used by those skilled in the art. Various modifications of the present disclosures will be readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: power-usage management system
20: electrical outlet
25: power-charging stand
30: vehicle
31: battery
32: external communication section
33: short-range communication section
34: GNSS apparatus
35: area determination section
40: power cable
41: plug
51: terminal apparatus
60: communication network
80: parking place
81: entrance/exit gate
82: gate apparatus
82a: wireless communication section
82b: external communication section
100: server
101: gate communication section
102: supply-target communication section
103: management processing section
104: storage section
105: fee-charge processing section
106: payment processing section

1. An information processing apparatus for managing a use of an energy, comprising a fee calculation section for calculating a usage fee to be fee-charged to a user, based on information regarding an energy supply amount received by an energy supply target of the user from an energy output section of a provider, and at least one of information on an energy supply speed at the time of an energy supply from the energy output section to the energy supply target, information on a type of generation method of the energy received by the energy supply and information on a type of the energy supply target receiving the energy supply.

2. The information processing apparatus according to claim 1, wherein the fee calculation section calculates a provision fee to be paid to the provider based on information regarding the energy supply amount and the at least one of information.

3. An information processing apparatus for managing a provision of an energy, comprising a fee calculation section for calculating a provision fee to be paid to a provider, based on information regarding an energy supply amount supplied by an energy output section of the provider to an energy supply target of a user, and at least one of information on an energy supply speed at the time of an energy supply from the energy output section to the energy supply target, information on a type of generation method of the energy received by the energy supply and information on a type of the energy supply target receiving the energy supply.

4. The information processing apparatus according to any one of claims 1 to 3, wherein the fee calculation section adds a fee for using or providing a parking space in which the energy supply target is parked within a disposing area where the energy output section is disposed, to the usage fee, the provision fee, or both.

5. A system for managing a use and/or a provision of energy, comprising:
the information processing apparatus according to any one of claims 1 to 4; and
a transmission apparatus for transmitting the at least one of information to the information processing apparatus.

6. A method for managing a use of an energy, comprising calculating a usage fee to be fee-charged to a user, based on information regarding an energy supply amount received by an energy supply target of the user from an energy output section of a provider, and at least one of information on an energy supply speed at the time of an energy supply from the energy output section to the energy supply target, information on a type of generation method of the energy received by the energy supply and information on a type of the energy supply target receiving the energy supply.

7. A method for managing a provision of an energy, comprising calculating a provision fee to be paid to a provider, based on information regarding an energy supply amount supplied by an energy output section of the provider to an energy supply target of a user, and at least one of information on an energy supply speed at the time of an energy supply from the energy output section to the energy supply target, information on a type of generation method of the energy received by the energy supply and information on a type of the energy supply target receiving the energy supply.
